(19) United States
(12) Patent Application Publication
(10) Pub. No.: US 2013/0048441 A1
(43) Pub. Date: Feb. 28, 2013

(54) COOLING DEVICE FOR A BRAKE CLAMP

(71) Applicant: Wayne-Ian Moore, Changhua City (TW)

(72) Inventor: Wayne-Ian Moore, Changhua City (TW)

(21) Appl. No.: 13/220,688

(22) Filed: Aug. 30, 2011

(51) Int. Cl. F16D 65/847; F16D 55/22

(52) U.S. Cl. 188/71.6

(57) ABSTRACT

A cooling device for a brake clamp includes a cooling device mounted on the hub of the bicycle wheel, a receiving room formed in the cooling device, an air vent defined on the peripheral of the cooling device and communicating with the receiving room, a receiving space formed on the peripheral of the cooling device and located adjacent to the air vent. Therefore, a brake clamp is partially received in the receiving space and the airflow from the air vent blows toward the brake clamp directly and continuously so as to cool the brake clamp.

### BACKGROUND OF THE INVENTION

1. Field of the Invention

The present invention relates to a cooling device, and more particularly to a cooling device for a brake clamp on bicycles.

2. Description of Related Art

A bicycle brake is used to slow down or stop a bicycle and a disk brake is the well-known type of the bicycle brake. The disk brake is a device for slowing or stopping the rotation of a wheel when it is in motion. A rotor is usually made of cast iron. This is connected to the wheel and/or the axle. To stop the wheel, friction material in the form of brake pads (mounted on a device called a brake clamp) is forced mechanically, hydraulically, pneumatically or electromagnetically against both sides of the rotor. Therefore, a friction causes the disc and attached wheel to slow or stop.

However, the brake action produces a lot of heat, and if the temperature of the rotor or the temperature of the brake pad increases, the disk brake cannot work effectively. This phenomenon is known as brake fade. Thus, how to reduce the temperature during the brake action is an important issue.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved cooling device.

To achieve the objective, a cooling device for a brake clamp comprises a cooling device mounted on the hub of the bicycle wheel, a receiving room formed in the cooling device, an air vent defined on the peripheral of the cooling device and communicating with the receiving room, a receiving space formed on the peripheral of the cooling device and located adjacent to the air vent.

Wherein the dimension of the receiving space enlarges gradually toward the outside and the two sides of the receiving space clamp the brake clamp.

Therefore, a brake clamp is partially received in the receiving space and the airflow from the air vent blows toward the brake clamp directly and continuously so as to cool the brake clamp.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a cooling device for a brake clamp of the present invention;

FIG. 2 is an assembled view of the cooling device for a brake clamp of the present invention;

FIG. 3 is an assembled view for showing the cooling device for a brake clamp connected to a brake clamp; and

FIG. 4 is a right side view for showing the cooling device for a brake clamp connected to the brake clamp.

### DETAILED DESCRIPTION OF THE INVENTION

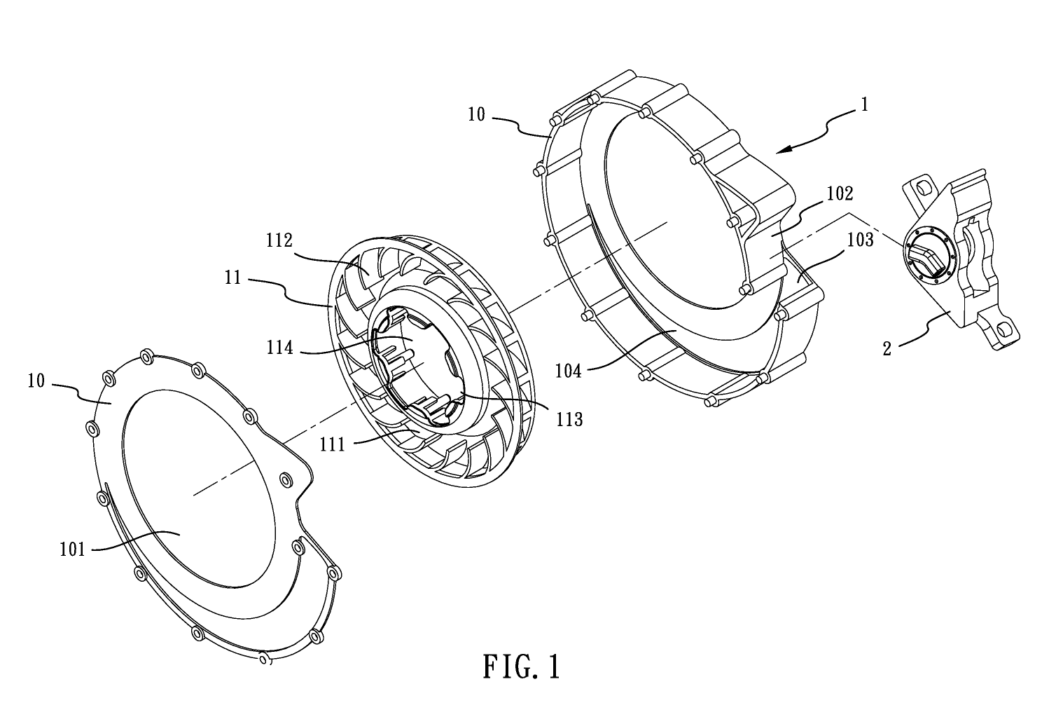

Referring to the drawing to FIG. 1, a cooling device for a brake clamp in accordance with the present invention comprises a cooling device 1. The cooling device 1 is mounted on the hub of the wheel. The cooling device 1 further comprises a cap 10, a turbine set 11 and a first hole 114. The first hole 114 is assembled to one end of the hub. A second hole 101 is opened through of the cap 10. An air vent 103 is defined on the peripheral of the cap 10. The outside of the cap 10 communicates with the inside of the cap 10 via the air vent 103. A receiving space 102 is formed on the peripheral of the cooling device 1. The receiving space 102 locates adjacent to the air vent 103. The turbine set 11 is mounted within the cap 10. A first hole 114 corresponding to the second hole 101 is opened on the turbine set 11 therethrough. Six lock grooves 113 are defined around the first hole 114 for mounting the turbine set 11 on one end of the hub. The cap 10 is mounted on one end of the hub and encircles the turbine set 11 so that the turbine set 11 is rotated within the cap 10 by the rotation of the hub to cause the airflow in the cap 10. A diversion groove 111 is defined on the lateral of the turbine set 11. The diversion groove 111 is defined around the first hole 114. A plurality of fans 112 is formed along the fringe of the diversion groove 111. The fans 112 extend toward the first hole 114. Therefore, when the turbine set 11 rotates within the cap 10, the airflow within the cap 10 flows via the diversion groove 111 and the fans 112, and blows out from the air vent for bring the heat away and cooling.

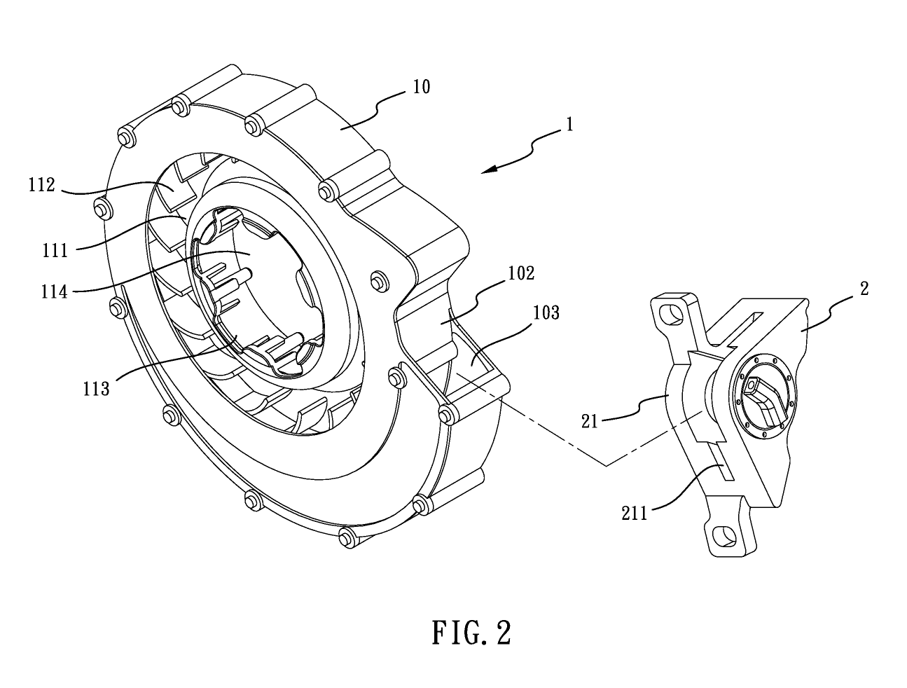

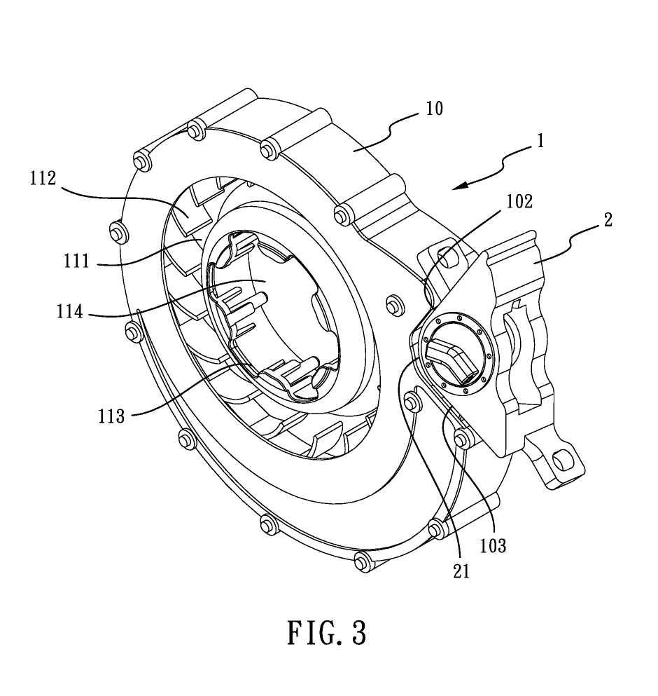

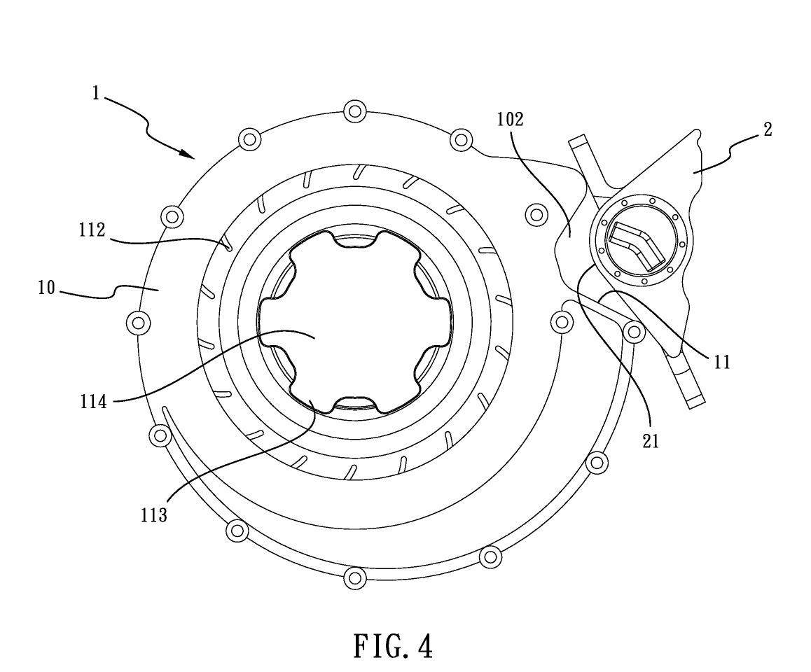

Referring to FIGS. 2-4, a receiving room 104 is formed in the cooling device 1. The diversion groove 111 is deposited in the receiving room 104. The air vent 103 is defined on the peripheral of the cooling device 1 and communicates with the receiving room 104. A receiving space 102 is formed on the peripheral of the cooling device 1. The receiving space 102 locates adjacent to the air vent 103. The dimension of the receiving space 102 enlarges gradually toward the outside. A brake clamp 2 is partially received in the receiving space 102 of the cooling device 1. The two sides of the receiving space 102 clamps the brake clamp 2. Therefore, the airflow from the air vent 103 blows toward the brake clamp 2 directly and continuously so as to cool the brake clamp 2. A round corner 21 is formed on the brake clamp 2. A brake disk room 211 is defined through the round corner 21. The brake disk room 211 has brake pads disposed on the inside wall thereof. The brake disk is partially received in the brake disk room 211. The brake pad is forced against both sides of the brake disk so that a friction causes the wheel to slow or stop. The friction causes the high temperature so that the brake disk and the brake clamp 2 expand with the high temperature. However, the brake clamp 2 is partially received in the receiving space 102 and the airflow from the air vent 103 blows toward the brake clamp 2 directly and continuously so as to cool the brake clamp 2.

Although the invention has been explained in relation to its preferred embodiment, it is to be understood that many other possible modifications and variations can be made without departing from the spirit and scope of the invention as hereinafter claimed.

What is claimed is:

1. A cooling device for a brake clamp comprising:
a cooling device mounted on the hub of the bicycle wheel, a receiving room formed in the cooling device, an air vent defined on the peripheral of the cooling device and communicating with the receiving room, a receiving space formed on the peripheral of the cooling device and located adjacent to the air vent;
thereby a brake clamp is partially received in the receiving space and the airflow from the air vent blows toward the brake clamp directly and continuously so as to cool the brake clamp.

2. The cooling device for a brake clamp as claimed in claim 1, wherein the dimension of the receiving space enlarges gradually toward the outside and the two sides of the receiving space clamp the brake clamp.
